(19) United States
(12) Patent Application Publication
(10) Pub. No.: US 2026/0243873 A1
(43) Pub. Date: Aug. 20, 2026

(54) MASTER OSCILLATOR POWER AMPLIFIER, FIBER LASER SYSTEM AND LIDAR

(71) Applicant: TUDATONG (SUZHOU) CO., LTD., Suzhou (CN)

(72) Inventors: Yiming HE, Suzhou (CN); Rui Yue, Suzhou (CN); Yunzhao Chen, Suzhou (CN); Xianglong Zhu, Suzhou (CN); Qing Sun, Suzhou (CN)

(73) Assignee: TUDATONG (SUZHOU)CO., LTD., Suzhou (CN)

(21) Appl. No.: 19/542,564

(22) Filed: Feb. 17, 2026

(30) Foreign Application Priority Data
Feb. 18, 2025 (CN) 202520255629.4

(51) Int. Cl. G01S 7/484; G01S 7/481

(52) U.S. Cl. CPC G01S 7/484; G01S 7/4813; G01S 7/4814; G01S 7/4818

(57) ABSTRACT

A master oscillator power amplifier for a Lidar is provided. The master oscillator power amplifier includes: a housing; a pump chip configured to provide first optical energy having a first wavelength and propagation along an optical path; a first optical element group, disposed in the housing and configured to pre-process the first optical energy; a gain fiber collimator, coupled to a gain fiber and configured to couple the pre-processed first optical energy into the gain fiber; and a dichroic mirror, disposed on the optical path between the first optical element group and the gain fiber collimator, and configured to direct the pre-processed first optical energy toward the gain fiber collimator. By coupling and integrating discrete optical devices into the housing, the integration level and stability are improved. The dichroic mirror shortens a fiber length, reduces fiber fusion splicing points, and enhances manufacturability.

### TECHNICAL FIELD

The present disclosure relates to the technical field of Lidar, and in particular, to a master oscillator power amplifier module for a Lidar, a fiber laser system, and the Lidar.

### BACKGROUND

As the light source of a vehicle-mounted Lidar, the performance of a fiber laser directly affects key indicators of the Lidar, such as ranging performance, accuracy, cost, and reliability. Currently, a solution where discrete devices are fusion-spliced to optical fibers is generally adopted in the market, but presents a number of problems. First, the manufacturing process is complex, involving multiple precise steps, which increases production difficulty and reduces efficiency. Secondly, the degree of automation is low, requiring extensive manual intervention, which leads to high costs and instability in the production process. In addition, the complex process and low automation make it difficult to achieve large-scale mass production of the products. As the fusion splicing joints between the discrete devices and the optical fibers are prone to failure, the stability and service life of the Lidar are affected.

The methods described in this section are not necessarily those that have been previously envisioned or adopted. Unless otherwise indicated, none of the methods described in this section should be assumed to be the prior art merely because they are included in this section. Similarly, unless otherwise indicated, the problems mentioned in this section should not be considered as having been recognized in any prior art.

### SUMMARY

The present disclosure is intended to solve at least one of the technical problems existing in the background. In view of this, an objective of the present disclosure is to provide a master oscillator power amplifier module for a Lidar, a fiber laser system, and the Lidar, so as to improve the integration level and stability, reduce fiber fusion splicing points, enhance manufacturability, and lower costs.

According to a first aspect of an embodiment of the present disclosure, there is provided a master oscillator power amplifier module for a Lidar. The master oscillator power amplifier module includes: a housing; a pump chip, disposed in the housing and configured to provide first optical energy with a first wavelength, where the first optical energy propagates along an optical path; a first optical element group, disposed in the housing and configured to pre-process the first optical energy; a gain fiber collimator, coupled to a gain fiber and configured to couple the pre-processed first optical energy into the gain fiber; and a dichroic mirror, disposed on the optical path between the first optical element group and the gain fiber collimator, and configured to direct the pre-processed first optical energy toward the gain fiber collimator.

According to a second aspect of an embodiment of the present disclosure, there is provided a fiber laser system. The fiber laser system includes: the master oscillator power amplifier module according to the first aspect above; a seed light chip, disposed in the housing of the master oscillator power amplifier module and configured to provide a seed light pulse; and a seed light collimator, coupled to the gain fiber and configured to couple the seed light pulse into the gain fiber.

According to a third aspect of an embodiment of the present disclosure, there is provided a fiber laser system. The fiber laser system includes: the master oscillator power amplifier module according to the first aspect above; a seed light module, disposed outside the housing of the master oscillator power amplifier module and configured to provide a seed light pulse; and a seed light collimator, coupled to the gain fiber and configured to couple the seed light pulse into the gain fiber.

According to a fourth aspect of an embodiment of the present disclosure, there is provided a Lidar. The Lidar includes: the fiber laser system according to the second aspect above or the third aspect above.

According to one or more embodiments of the present disclosure, there is provided a master oscillator power amplifier module for a Lidar, a fiber laser system, and the Lidar. By coupling and integrating original discrete optical devices into the housing, the integration level and stability of the system are improved. In addition, the master oscillator power amplifier module according to the embodiment of the present disclosure uses the dichroic mirror to replace the beam combiner and the beam splitter of the fiber laser in the related art, thus greatly shortening a required fiber length, reducing fiber fusion splicing points, and enhancing manufacturability.

### BRIEF DESCRIPTION OF THE DRAWINGS

The drawings exemplarily illustrate embodiments and constitute part of the specification, and together with the textual description of the specification, serve to illustrate exemplary implementations of the embodiments. The embodiments shown are for illustrative purposes only and do not limit the scope of claims. In all the drawings, the same reference numerals refer to the same elements or similar but not necessarily identical elements.

FIG. 1 shows a schematic diagram of a master oscillator power amplifier module for a Lidar in the related art;

FIG. 2 shows a schematic diagram of a master oscillator power amplifier module for a Lidar according to an embodiment of the present disclosure;

FIG. 3 shows a schematic diagram of a master oscillator power amplifier module for a Lidar according to an embodiment of the present disclosure; and

FIG. 4 shows a schematic diagram of a master oscillator power amplifier module for a Lidar according to an embodiment of the present disclosure.

### DESCRIPTION OF REFERENCE SIGNS

10: master oscillator power amplifier module; 20: gain fiber;
100: housing; 200: pump chip; 400: gain fiber collimator; 500: dichroic mirror;
300: first optical element group; 320: fast-axis collimator; 340: slow-axis collimator; 360: first mirror;
600: second optical element group; 610: beam splitter; 620: isolator; 630: second mirror; 640: third sub-light pulse collimator; 650: fourth sub-light pulse collimator;
720: seed light chip; and 740: seed light collimator.

### DETAILED DESCRIPTION OF THE EMBODIMENTS

Further detailed description of the present disclosure will be provided below in conjunction with the drawings and embodiments. It can be understood that the specific embodiments described herein are merely to illustrate the related invention, and are not intended to limit the invention. Additionally, it should be noted that for ease of description, only parts related to the related invention are shown in the drawings.

It should be noted that the embodiments of the present disclosure and the features in the embodiments may be combined with each other unless without conflict. Unless otherwise explicitly stated in the context, if the number of elements is not specifically limited, the element can be one or plural. In addition, the numbers of steps or functional modules used in the present disclosure are only used to identify each step or functional module, and are not used to limit the execution order of each step or the connection relationship between each functional module.

In the present disclosure, unless otherwise specified, the use of the terms “first”, “second”, etc. to describe various elements is not intended to define the positional relationship, temporal relationship, or importance relationship of these elements, and such terms are simply used to distinguish one element from another element. In some examples, the first element and the second element may refer to the same instance of the element, while in some cases, they may also refer to different instances based on contextual descriptions.

In the present disclosure, the terms used in the description of various described examples are for the purpose of describing specific examples only, and are not intended to be limiting. Unless otherwise explicitly stated in the context, if the number of elements is not specifically limited, the element can be one or plural. In addition, the term “and/or” used in the present disclosure encompasses any one and all possible combinations of the listed items.

As the core light source of a vehicle-mounted Lidar, the performance of a fiber laser largely determines key indicators of the Lidar, such as ranging performance, ranging accuracy, cost, and reliability. Currently, most fiber lasers used in the market adopt a solution where discrete devices are fusion-spliced to optical fibers, which presents a number of problems. First, the manufacturing process is relatively complex and requires precise operations in multiple steps, which not only increases the difficulty of production but also makes it difficult to improve production efficiency. Secondly, the degree of automation is low, and the production process requires extensive manual intervention, which not only increases labor costs but also makes it difficult to ensure stability and consistency in the production process. In addition, the complex process and low degree of automation lead to high product costs, making it difficult to achieve large-scale mass production. Furthermore, as the fusion splicing joints between the discrete devices and the optical fibers are prone to failure, the stability and service life of the Lidar are also affected. These problems have long constrained the widespread application of the fiber lasers in the field of the vehicle-mounted Lidar. Therefore, improving the optical arrangement of a fiber laser system, especially a master oscillator power amplifier module, enhancing the integration level and stability of the system, reducing fiber fusion splicing points, improving manufacturability, and reducing costs are technical problems urgently to be solved in this field.

In view of this, according to a first aspect of an embodiment of the present disclosure, there is provided a master oscillator power amplifier module for a Lidar. By coupling and integrating original discrete optical devices into the housing through spatial optical path coupling, the integration level and stability of the system are improved. In addition, the master oscillator power amplifier module according to the embodiment of the present disclosure uses the dichroic mirror to replace the beam combiner and the beam splitter of the fiber laser in the related art, thus greatly shortening a required fiber length, reducing fiber fusion splicing points, and enhancing manufacturability.

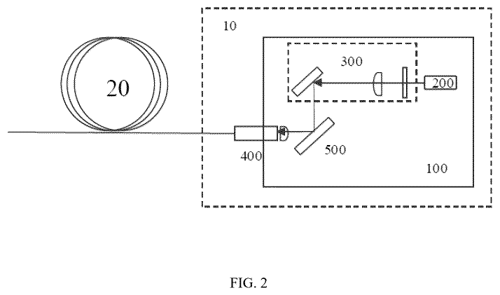

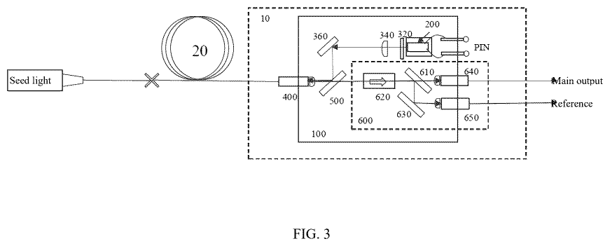

FIG. 2 and FIG. 3 show schematic diagrams of a master oscillator power amplifier module 10 according to an embodiment of the present disclosure.

The master oscillator power amplifier module 10 includes: a housing 100; a pump chip 200, disposed in the housing 100 and configured to provide first optical energy with a first wavelength, where the first optical energy propagates along an optical path; a first optical element group 300, disposed in the housing 100 and configured to pre-process the first optical energy; a gain fiber collimator 400, coupled to a gain fiber 20 and configured to couple the pre-processed first optical energy into the gain fiber 20; and a dichroic mirror 500, disposed on the optical path between the first optical element group 300 and the gain fiber collimator 400, and configured to direct the pre-processed first optical energy toward the gain fiber collimator 400.

In some embodiments, the pump chip 200 may be a semiconductor laser pump chip, such as a GaAs-based semiconductor laser or an InP-based semiconductor laser. The pump chip 200 may be fixed to the housing 100 via a process such as thermal deposition (e.g., a ceramic heat sink). The pump chip 200 includes pump pins connected to an external drive circuit and may provide first optical energy with a first wavelength as pump light for a fiber laser system. The first optical energy may, for example, propagate along an optical path indicated by the solid arrowed line as shown in FIG. 2. The first optical energy may include a variety of forms, such as continuous light, pulsed light, or quasi-continuous wave, the specific form depending on its design and application requirements, without any limitation thereto. The wavelength of the first optical energy matches an absorption spectrum of a gain medium in the gain fiber, and the energy provided by the pump chip may amplify seed light in the gain fiber, thereby obtaining a laser output with desired power.

In some embodiments, the module 10 may further include a first optical element group 300 disposed in the housing 100 and configured to pre-process the first optical energy. The first optical element group 300 may include at least one of a fast-axis collimator 320 and a slow-axis collimator 340. Taking the first optical element group 300 including both a fast-axis collimator 320 and a slow-axis collimator 340 shown in FIG. 2 and FIG. 3 as an example, the first optical energy generated by the pump chip 200 passes through the fast-axis collimator 320 and the slow-axis collimator 340 respectively, thereby adjusting a spot size and shape or a beam divergence angle, such that more pump light energy can pass through the gain fiber collimator 400 and be absorbed by the gain fiber.

In some embodiments, the gain fiber collimator 400 may be an integrated collimator or a combination of a separate fiber ferrule and a lens. The gain fiber collimator 400 may be configured to collect a divergent light pulse and produce more parallel beams with reduced or minimal divergence. The lens combined with the separate fiber ferrule may be, for example, a single plano-convex lens or a lens group. In Lidar applications, it is crucial for the light pulse to have good laser beam quality. The collimator according to the embodiment of the present disclosure may be configured to achieve desired characteristics, such as a beam diameter, divergence, a numerical aperture, and a focal length. In the art, a beam propagation ratio or a beam quality factor (also referred to as an M² factor) is commonly used to measure the quality of a laser beam, where the M² factor indicates a degree of variation of the beam relative to an ideal Gaussian beam. The M² factor thus reflects how well a collimated beam can be focused or how well a divergent beam can be collimated. The collimator according to the embodiment of the present disclosure may also be configured to, for example, meet scanning resolution requirements of the Lidar while maintaining the desired M² factor.

With continued reference to FIG. 2 and FIG. 3, in the embodiment of the present disclosure, a dichroic mirror 500 disposed on the optical path between the first optical element group 300 and the gain fiber collimator 400 is further included, which is configured to direct the pre-processed first optical energy toward the gain fiber collimator 400.

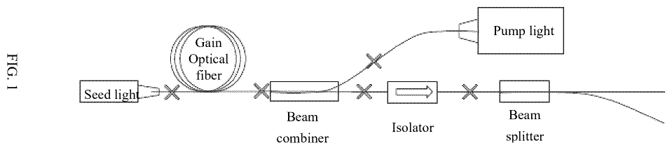

As mentioned above, the master oscillator power amplifier module according to the embodiment of the present disclosure uses the dichroic mirror to replace the beam combiner and the beam splitter of the fiber laser in the related art. FIG. 1 shows a schematic diagram of a fiber laser system in the related art. The beam combiner shown in FIG. 1 typically uses precise fiber fusion splicing technology to couple the optical energy from multiple input fibers into a single output fiber. During manufacturing, the input fibers are first bundled, then fused and tapered to form a fused and tapered fiber bundle, and finally the fused and tapered fiber bundle is fusion-spliced to the output fiber. For the beam splitter shown in FIG. 1, a tapered structure is formed by fusing and tapering, and then fusion-spliced to multiple output fibers. It can be seen that the fiber laser in the related art extensively utilize fiber connections, and thus the optical fiber used in the entire system is generally long. In addition, fiber fusion splicing joints are prone to failure. For example, during fusion splicing, poor fiber cleaving (e.g., tilted or burred end surfaces) will lead to bubbles or cracks at fusion splicing points, and uneven fiber cleaved surfaces or improper force application during fusion splicing will result in insufficient mechanical strength at the fusion splicing joints.

The master oscillator power amplifier module according to the embodiment of the present disclosure may thus at least partially solve the above problems. In some embodiments, depending on specific wavelength selectivity requirements, the dichroic mirror may be coated in design to achieve effective separation and guidance of pump light and signal light. With continued reference to FIG. 2 and FIG. 3, the first optical energy may be pump light with a wavelength of 940 nm. After passing through the fast-axis collimator 320 and the slow-axis collimator 340, the pre-processed first optical energy is redirected via a first mirror 360. In the optical path arrangement shown in FIG. 2 and FIG. 3, by controlling a thickness and a refractive index of a coating layer during a design phase, the dichroic mirror 500 may be specifically set to have high reflectivity at 940 nm, such that the first optical energy can be redirected again and then coupled into the gain fiber 20 via the gain fiber collimator 400.

Through the dichroic mirror in the master oscillator power amplifier module according to the embodiment of the present disclosure, the fiber length required for the fiber laser system can be significantly shortened while reducing the fiber fusion splicing points and enhancing the manufacturability.

In some embodiments, the master oscillator power amplifier module 10 further includes: a second optical element group 600 disposed in the housing 100, where the second optical element group 600 is configured to receive a second light pulse emitted from the gain fiber 20 and directed via the dichroic mirror 500, and the second light pulse has a second wavelength different from the first wavelength.

In some embodiments, referring to FIG. 3, the second optical element group 600 is configured to receive a second light pulse emitted from the gain fiber 20 and having a second wavelength different from the first wavelength. The second light pulse may be signal light amplified in the gain fiber 20. Taking the second light pulse with a wavelength of 1,550 nm as an example, in addition to being set to have high reflectivity at 940 nm, the dichroic mirror 500 may further be set to have high transmittance at 1,550 nm, thereby separating the second light pulse from the first optical energy and directing the second light pulse toward the second optical element group 600 for transmission. It should be understood that the description herein for the specific setting of the dichroic mirror is merely exemplary and depends on the specific optical path design, and other settings are also possible.

In some embodiments, the second optical element group 600 may include a beam splitter 610, an isolator 620 disposed between the beam splitter 610 and the dichroic mirror 500, a second mirror 630, a third sub-light pulse collimator 640, and a fourth sub-light pulse collimator 650.

In some embodiments, the isolator 620 is configured to provide unidirectional transmission of the second light pulse. In the embodiment shown in FIG. 3, the isolator 620 allows the second light pulse to be transmitted only from the dichroic mirror 500 toward the beam splitter 610, while blocking light transmission in an opposite direction. After reaching the beam splitter 610, the second light pulse is split into a third sub-light pulse and a fourth sub-light pulse. In the embodiment shown in FIG. 3, the beam splitter 610 may be set to allow the third sub-light pulse (e.g., more than 99% of the light pulse) to be directly transmitted through the beam splitter 610 into the third sub-light pulse collimator 640, thereby coupling to a main output fiber. The fourth sub-light pulse (e.g., the remaining less than 1% of the light pulse) is redirected by the beam splitter 610 and directed via the second mirror 630 to the fourth sub-light pulse collimator 650, thereby coupling to a reference optical fiber. It should be noted that, similar to the gain fiber collimator 400, the third sub-light pulse collimator 640 and the fourth sub-light pulse collimator 650 may also be integrated collimators or combinations of separate fiber ferrules and lenses, and may be configured to meet, for example, the scanning resolution requirements of the Lidar, while maintaining the desired M² factor, which will not be repeated herein.

In some embodiments, the housing of the master oscillator power amplifier module 10 may further include a bottom shell and side walls. The pump chip 200, the first optical element group 300, the dichroic mirror 500, and optionally the beam splitter 610, the isolator 620, and the second mirror 630 may be disposed on the bottom shell. The pump chip 200 may be soldered to the bottom shell via a ceramic heat sink or bonded to the bottom shell via conductive adhesive, and the first optical element group 300, the dichroic mirror 500, and optionally the beam splitter 610, the isolator 620, and the second mirror 630 may be bonded to the bottom shell via conductive adhesive.

In some embodiments, the gain fiber collimator 400 and optionally the third sub-light pulse collimator 640 and the fourth sub-light pulse collimator 650 may be disposed on the side walls of the housing, for example, the gain fiber collimator 400 may be embedded in a first side wall of the housing, and the third sub-light pulse collimator 640 and the fourth sub-light pulse collimator 650 may be embedded in a second side wall opposite to the first side wall. Thus, the dichroic mirror 500 may direct the first optical energy toward the gain fiber collimator 400 embedded in the first side wall of the housing, and then the first optical energy may be coupled to the gain fiber.

In some embodiments, the gain fiber collimator 400 may also be disposed on an outer side surface of the first side wall of the housing (not shown in the figure), and the third sub-light pulse collimator 640 and the fourth sub-light pulse collimator 650 may also be disposed on an outer side surface of the second side wall opposite to the first side wall (not shown in the figure). In this example, optical windows may further be formed in the corresponding side walls of the housing. For example, a first optical window may be formed in the first side wall, through which the dichroic mirror 500 may direct the first optical energy toward the gain fiber collimator 400 disposed at a corresponding position on an outer side surface of the housing. A third optical window and a fourth optical window may be formed in the second side wall, where through the third optical window, the beam splitter 610 may direct the third sub-light pulse toward the third sub-light pulse collimator 640, and through the fourth optical window, the second mirror 630 may direct the fourth sub-light pulse toward the fourth sub-light pulse collimator 650.

In some embodiments, the housing may be made of metal. The metal housing may provide higher mechanical stability, and also has good thermal conductivity and a low coefficient of thermal expansion, which can effectively dissipate heat and maintain the relative position stability of optical elements.

In some embodiments, the housing may further include a cover portion (not shown in the figure), and hermetic sealing of the housing can be achieved via high-temperature fusion, thereby better protecting optical components inside the housing.

In some embodiments, the housing may also exclude side walls and a cover portion. For example, the optical devices in the module 10 may be disposed on a base plate, and the pump chip may be packaged separately, thereby further reducing a volume of the master oscillator power amplifier module.

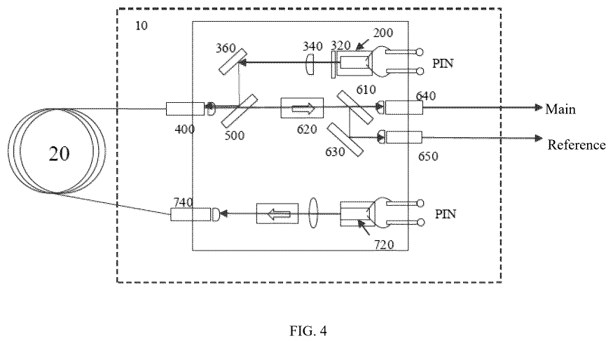

According to a second aspect of an embodiment of the present disclosure, there is provided a fiber laser system. FIG. 4 shows a schematic diagram of a fiber laser system according to an embodiment of the present disclosure, which differs from the embodiments illustrated in FIG. 2 and FIG. 3 in that the master oscillator power amplifier module 10 further includes a seed light chip 720 and a seed light collimator 740, thereby achieving full integration of a pump optical path and a signal optical path in the master oscillator power amplifier module 10.

In the embodiment illustrated in FIG. 4, the seed light chip 720 is also disposed on the housing 100 and is configured to provide a seed light pulse. The seed light collimator 740 is coupled to the gain fiber 20 and configured to couple the seed light pulse into the gain fiber 20. After the seed light pulse enters the gain fiber 20, the gain fiber 20 combines the energy provided by the pump chip 200 with the seed light pulse to amplify an optical signal.

According to a third aspect of an embodiment of the present disclosure, there is provided another fiber laser system. With continued reference to FIG. 3, the fiber laser system according to the embodiment of the present disclosure includes: the master oscillator power amplifier module 10 according to any embodiment in the first aspect above; a seed light module disposed outside the housing of the master oscillator power amplifier module 10 and configured to provide a seed light pulse; and a seed light collimator.

In some embodiments, as shown in FIG. 3, the seed light collimator disposed outside the housing of the master oscillator power amplifier module 10 may be coupled to the gain fiber 20 and is configured to couple the seed light pulse into the gain fiber 20 for light amplification. According to a fourth aspect of an embodiment of the present disclosure, there is provided a Lidar. The Lidar includes the fiber laser system according to any one of the embodiments in the second aspect above, or the fiber laser system according to any one of the embodiments in the third aspect above.

For the technical effects achievable by the fiber laser system and the Lidar according to the embodiments of the present disclosure, reference can be made to the relevant descriptions in the embodiments illustrated in FIG. 2 and FIG. 3, which will not be repeated herein.

The following describes some exemplary solutions of the present disclosure.
Solution 1. A master oscillator power amplifier module for a Lidar, including:
a housing;
a pump chip, disposed in the housing and configured to provide first optical energy with a first wavelength, where the first optical energy propagates along an optical path;
a first optical element group, disposed in the housing and configured to pre-process the first optical energy;
a gain fiber collimator, coupled to a gain fiber and configured to couple the pre-processed first optical energy into the gain fiber; and
a dichroic mirror, disposed on the optical path between the first optical element group and the gain fiber collimator, and configured to direct the pre-processed first optical energy toward the gain fiber collimator.
Solution 2. The master oscillator power amplifier module according to Solution 1, where the first optical element group includes at least one of the following: a slow-axis collimator and a fast-axis collimator.
Solution 3. The master oscillator power amplifier module according to any one of Solutions above, where the first optical element group further includes at least one first mirror, disposed at one end of the first optical element group close to the dichroic mirror on the optical path, and configured to direct the pre-processed first optical energy toward the dichroic mirror.
Solution 4. The master oscillator power amplifier module according to any one of Solutions above, where the gain fiber collimator is disposed on a first sidewall of the housing, the first sidewall is provided with a first optical window, and the dichroic mirror directs the pre-processed first optical energy toward the gain fiber collimator via the first optical window.
Solution 5. The master oscillator power amplifier module according to any one of Solutions above, further including:
a second optical element group disposed in the housing, where the second optical element group receives a second light pulse emitted from the gain fiber and directed via the dichroic mirror, and the second light pulse has a second wavelength different from the first wavelength.
Solution 6. The master oscillator power amplifier module according to Solution 5, where the second optical element group includes:
a beam splitter, configured to split the second light pulse into a third sub-light pulse and a fourth sub-light pulse, and
an isolator, disposed between the beam splitter and the dichroic mirror.
Solution 7. The master oscillator power amplifier module according to Solution 5 or 6, where the second optical element group further includes:
at least one second mirror, configured to direct the fourth sub-light pulse;
a third sub-light pulse collimator, configured to pre-process the third sub-light pulse from the beam splitter; and
a fourth sub-light pulse collimator, configured to pre-process the fourth sub-light pulse from the beam splitter and directed via the at least one second mirror.
Solution 8. The master oscillator power amplifier module according to Solution 7, where the third sub-light pulse collimator and the fourth sub-light pulse collimator are disposed on a second sidewall of the housing different from the first sidewall, and the second sidewall is provided with a third optical window and a fourth optical window, where the beam splitter directs the third sub-light pulse toward the third sub-light pulse collimator via the third optical window, and the at least one second mirror directs the fourth sub-light pulse toward the fourth sub-light pulse collimator via the fourth optical window.
Solution 9. The master oscillator power amplifier module according to any one of Solutions 5 to 8, where at least one of the gain fiber collimator, the third sub-light pulse collimator, and the fourth sub-light pulse collimator is an integrated collimator; or
at least one of the gain fiber collimator, the third sub-light pulse collimator, and the fourth sub-light pulse collimator is a combination of a separate fiber ferrule and a lens.
Solution 10. The master oscillator power amplifier module according to any one of Solutions 5 to 8, where the first optical element group, the second optical element group, the gain fiber collimator, and the dichroic mirror are bonded to the housing.
Solution 11. The master oscillator power amplifier module according to any one of Solutions 1 to 10, where the pump chip is soldered to or bonded to the housing.
Solution 12. The master oscillator power amplifier module according to any one of Solutions 1 to 11, where the housing further includes a cover portion to provide hermetic sealing.
Solution 13. The master oscillator power amplifier module according to any one of Solutions 1 to 12, where the housing is made of metal.
Solution 14. A fiber laser system, including:
the master oscillator power amplifier module according to any one of Solutions 1 to 13;
a seed light chip, disposed in the housing of the master oscillator power amplifier module and configured to provide a seed light pulse; and
a seed light collimator, coupled to the gain fiber and configured to couple the seed light pulse into the gain fiber.
Solution 15. A fiber laser system, including:
the master oscillator power amplifier module according to any one of Solutions 1 to 13;
a seed light module, disposed outside the housing of the master oscillator power amplifier module and configured to provide a seed light pulse; and
a seed light collimator, coupled to the gain fiber and configured to couple the seed light pulse into the gain fiber.
Solution 16. A Lidar, including:
the fiber laser system according to Solution 14 or Solution 15.

The above descriptions are only preferred embodiments of the present disclosure and explanations of the technical principles applied. Those skilled in the art should understand that the scope of the invention involved in the embodiments of the present disclosure is not limited to technical solutions formed by specific combinations of the above technical features, and should also cover other technical solutions formed by any combination of the above technical features or their equivalent features without departing from the above inventive concept, for example, technical solutions formed by mutually replacing the above features with (but not limited to) technical features with similar functions disclosed in the embodiments of the present disclosure.

1. A master oscillator power amplifier module for a Lidar, comprising:
a housing;
a pump chip, disposed in the housing and configured to provide first optical energy with a first wavelength, wherein the first optical energy propagates along an optical path;
a first optical element group, disposed in the housing and configured to pre-process the first optical energy;
a gain fiber collimator, coupled to a gain fiber and configured to couple the pre-processed first optical energy into the gain fiber; and
a dichroic mirror, disposed on the optical path between the first optical element group and the gain fiber collimator, and configured to direct the pre-processed first optical energy toward the gain fiber collimator.

2. The master oscillator power amplifier module according to claim 1, wherein the first optical element group comprises at least one of the following: a slow-axis collimator and a fast-axis collimator.

3. The master oscillator power amplifier module according to claim 1, wherein the first optical element group further comprises at least one first mirror, disposed at one end of the first optical element group close to the dichroic mirror on the optical path, and configured to direct the pre-processed first optical energy toward the dichroic mirror.

4. The master oscillator power amplifier module according to claim 1, wherein the gain fiber collimator is disposed on a first sidewall of the housing, the first sidewall is provided with a first optical window, and the dichroic mirror directs the pre-processed first optical energy toward the gain fiber collimator via the first optical window.

5. The master oscillator power amplifier module according to claim 1, further comprising:
a second optical element group disposed in the housing, wherein the second optical element group receives a second light pulse emitted from the gain fiber and directed via the dichroic mirror, and the second light pulse has a second wavelength different from the first wavelength.

6. The master oscillator power amplifier module according to claim 5, wherein the second optical element group comprises:
a beam splitter, configured to split the second light pulse into a third sub-light pulse and a fourth sub-light pulse, and an isolator, disposed between the beam splitter and the dichroic mirror.

7. The master oscillator power amplifier module according to claim 6, wherein the second optical element group further comprises:
at least one second mirror, configured to direct the fourth sub-light pulse;
a third sub-light pulse collimator, configured to pre-process the third sub-light pulse from the beam splitter; and
a fourth sub-light pulse collimator, configured to pre-process the fourth sub-light pulse from the beam splitter and directed via the at least one second mirror.

8. The master oscillator power amplifier module according to claim 7, wherein the third sub-light pulse collimator and the fourth sub-light pulse collimator are disposed on a second sidewall of the housing different from the first sidewall, and the second sidewall is provided with a third optical window and a fourth optical window, wherein the beam splitter directs the third sub-light pulse toward the third sub-light pulse collimator via the third optical window, and the at least one second mirror directs the fourth sub-light pulse toward the fourth sub-light pulse collimator via the fourth optical window.

9. The master oscillator power amplifier module according to claim 7, wherein at least one of the gain fiber collimator, the third sub-light pulse collimator, and the fourth sub-light pulse collimator is an integrated collimator; or
at least one of the gain fiber collimator, the third sub-light pulse collimator, and the fourth sub-light pulse collimator is a combination of a separate fiber ferrule and a lens.

10. The master oscillator power amplifier module according to claim 5, wherein the first optical element group, the second optical element group, the gain fiber collimator, and the dichroic mirror are bonded to the housing.

11. The master oscillator power amplifier module according to claim 1, wherein the pump chip is soldered to or bonded to the housing.

12. The master oscillator power amplifier module according to claim 1, wherein the housing further comprises a cover portion to provide hermetic sealing.

13. The master oscillator power amplifier module according to claim 1, wherein the housing is made of metal.

14. A fiber laser system, comprising:
the master oscillator power amplifier module according to claim 1;
a seed light chip, disposed in the housing of the master oscillator power amplifier module and configured to provide a seed light pulse; and
a seed light collimator, coupled to the gain fiber and configured to couple the seed light pulse into the gain fiber.

15. A fiber laser system, comprising:
the master oscillator power amplifier module according to claim 1;
a seed light module, disposed outside the housing of the master oscillator power amplifier module and configured to provide a seed light pulse; and
a seed light collimator, coupled to the gain fiber and configured to couple the seed light pulse into the gain fiber.

16. A Lidar, comprising:
the fiber laser system according to claim 14.

17. A Lidar, comprising:
the fiber laser system according to claim 15.
